(19) United States
(12) Patent Application Publication
(10) Pub. No.: US 2012/0057197 A1
(43) Pub. Date: Mar. 8, 2012

(54) PRINTING SYSTEM, SERVER DEVICE, PRINTING DEVICE AND METHOD FOR USING THE SAME

(75) Inventor: Okiharu Matsuda, Shizuoka (JP)

(73) Assignee: TOSHIBA TEC KABUSHIKI KAISHA, Tokyo (JP)

(21) Appl. No.: 13/219,848

(22) Filed: Aug. 29, 2011

(30) Foreign Application Priority Data
Sep. 3, 2010 (JP) 2010-198187

(51) Int. Cl. G06K 15/02

(52) U.S. Cl. 358/1.15

(57) ABSTRACT

According to one embodiment, a printing system including a printing device and a server device is disclosed. The printing device includes a memory unit configured to store usage information. Further, the server device includes a communications unit configured to communicate with the printing device; an aggregation unit configured to obtain the usage information from the printing device via the communications unit and aggregate the obtained usage information; and a recommendation information generation unit configured to generate recommendation information for the printing device based on the usage information aggregated by the aggregation unit and provide the recommendation information to the printing device via the communications unit.

### CROSS-REFERENCE TO RELATED APPLICATION

This application is based upon and claims the benefit of priority from Japanese Patent Application No. 2010-198187, filed on Sep. 3, 2010, the entire contents of which are incorporated herein by reference.

### FIELD

Embodiments described herein relate generally to a printing system, a server device, a printing device and a method for using the printing device and the server device, providing recommendation information to reduce electric power consumption in the printing device.

### BACKGROUND

In the related art, manufacturers of label printers may provide power consumption information to users. Specifically, such label printers provide users only with a maximum value of allowable power consumption, for example, by indicating the same on a product specification sheet. However, with this information, the users of the label printers may not recognize actual power consumption for ordinary printing operations.

As a result, the users of the label printers may not obtain power consumption information for ordinary printing operations (which may not indicate the maximum value of allowable power consumption) unless the users equip the label printers with separate power consumption measuring devices to measure power consumption of the label printers. Even if the users manage to measure the power consumption, it is challenging and impractical for them to carry out a specific method to utilize the measured power consumption in order to reduce power consumption of the label printers.

### BRIEF DESCRIPTION OF THE DRAWINGS

FIG. 1 is an exterior view showing an example of an exterior appearance of a printing device according to one embodiment.

FIG. 2 is an exterior view showing a manipulation unit and a display unit of the printing device.

FIG. 3 is a block diagram showing an example of a functional configuration of the printing device.

FIG. 4 is a block diagram showing an example of a configuration of a printing system according to one embodiment.

FIG. 5 is a flow chart showing an example of a recommendation process in the printing system.

FIG. 6 is a flow chart showing another example of the recommendation process in the printing system.

FIG. 7 is a graph showing an example of a method for determining recommendation information in the printing system.

FIGS. 8A and 8B represent a screen display of an example of the recommendation information in the printing system.

### DETAILED DESCRIPTION

According to one embodiment, a printing system including a printing device and a server device is disclosed. The printing device includes a memory unit configured to store usage information. Further, the server device includes a communications unit configured to communicate with the printing device; an aggregation unit configured to obtain the usage information from the printing device via the communications unit and aggregate the obtained usage information; and a recommendation information generation unit configured to generate recommendation information for the printing device based on the usage information aggregated by the aggregation unit and provide the recommendation information to the printing device via the communications unit.

The recommendation information generation unit may be configured to generate the recommendation information with respect to a usage environment of the printing device which includes at least one of a kind of a recording medium for use in the printing device, a kind of a ribbon for use in the printing device and a printing rate of the printing device.

The recommendation information generation unit may be configured to generate the recommendation information for the printing device based on at least one of an ambient temperature, a printing rate and a standby ratio.

The recommendation information generation unit may be configured to generate the recommendation information for reducing power consumption of the printing device.

The printing device may be configured to display on a display unit the recommendation information provided from the server device and change a usage environment of the printing device according to the recommendation information, upon receiving an instruction signal for accepting the recommendation information.

The recommendation information may include at least one of information on electric energy consumption depending on a supply for use in the printing device and information on electric energy consumption depending on a configuration of the printing device.

The usage information may include information on a plurality of usage environments of the printing device, and the recommendation information generated by the recommendation information generation unit may include information for reducing power consumption of the printing device with respect to the respective usage environments.

The usage information may include at least one of a supply, a working time, an operating time and an electric energy consumption of the printing device.

According to another embodiment a server device includes a communications unit configured to communicate with an external printing device and an aggregation unit configured to obtain usage information including at least one of a supply, a working time, an operating time and an electric energy consumption from the external printing device via the communications unit and configured to aggregate the obtained usage information. The server device further includes a recommendation information generation unit configured to generate recommendation information for the external printing device and provide the recommendation information to the external printing device via the communications unit.

The recommendation information generation unit may be configured to generate the recommendation information on a usage environment which includes at least one of a kind of a recording medium for use in the external printing device, a kind of a ribbon for use in the external printing device, and a printing rate of the external printing device.

The recommendation information generation unit may be configured to generate the recommendation information for the external printing device based on at least one of an ambient temperature, a printing rate, and a standby ratio.

The recommendation information generation unit may be configured to generate the recommendation information for reducing power consumption of the external printing device.

The aggregation unit may be configured to obtain the usage information from the external printing device at predetermined time intervals.

The recommendation information may include at least one of information on electric energy consumption depending on a supply for use in the external printing device and information on electric energy consumption depending on a configuration of the external printing device.

The usage information from the external printing device may include information on a plurality of usage environments of the external printing device, and the recommendation information generated by the recommendation information generation unit may include information for reducing power consumption of the printing device with respect to the respective usage environments.

According to still another embodiment, a printing device includes a memory unit configured to store usage information including at least one of a supply, a working time, an operating time and an electric energy consumption of the printing device. The printing device further includes a providing unit configured to provide the usage information to an external server device via a communications unit upon receiving a request for providing the usage information from the external server device.

The memory unit may include a real time clock configured to measure a working time and an operating time of the printing device.

The printing device may further include a control unit configured to display on a display unit recommendation information provided from the external server device and change a usage environment of the printing device according to the recommendation information, upon receiving an instruction signal for accepting the recommendation information.

The recommendation information may include the usage environment of the printing device which includes at least one of a kind of a recording medium for use in the printing device, a kind of a ribbon for use in the printing device, and a printing rate of the printing device.

The recommendation information may be generated based on at least one of an ambient temperature, a working rate and a standby ratio of the printing device.

Embodiments will now be described in detail with reference to the drawings.

In a printing system according to an embodiment, usage information (e.g., a supply, a working time, an operating time, and an electric energy consumption) of a printing device 1 is measured and transmitted to a power consumption aggregation server SS installed outside of a client such as the printing device 1. The usage information represents in detail a usage environment including the conditions and requirements for using the printing device 1 and how the printing device 1 is used in the usage environment. Specifically, the “supply” refers to consumables such as an ink ribbon and a printing paper. The “working time” refers to a period of time during which the printing device 1 has actually been working, and the “operating time” refers to a period of time during which the printing device 1 has been operating (i.e., working time +standby time). The “electric energy consumption” refers to the amount of electric energy consumed while the printing device 1 is used.

The power consumption aggregation server SS aggregates information on respective usage environments from a plurality of the printing devices and computes a pattern by which power consumption can be reduced. For example, the information on the “usage environment” for each of the printing devices may include information on any conditions and requirements for printing operations in the printing device such as types of an ink ribbon, a recording medium for use in printing, an operating time, electric energy consumption and temperature. The printing device 1 receives recommendation information on how to achieve a reduction in power consumption from the power consumption aggregation server SS, thereby providing the user with information on functional comparison between the plural usage environments, how to use the printing device 1 or how to set printing conditions thereof in order to suppress the power consumption.

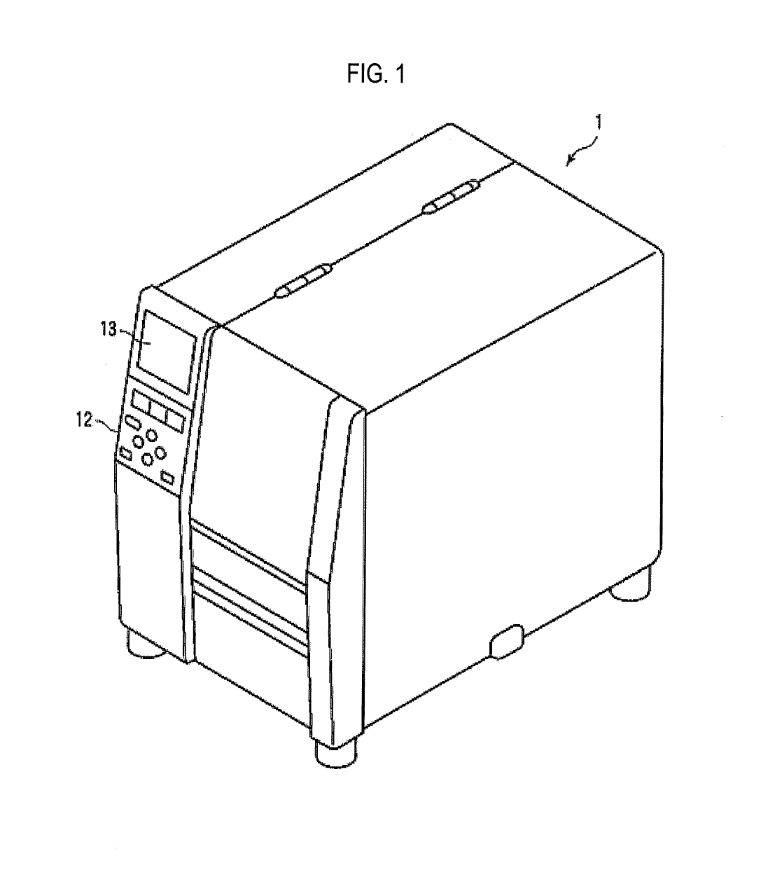

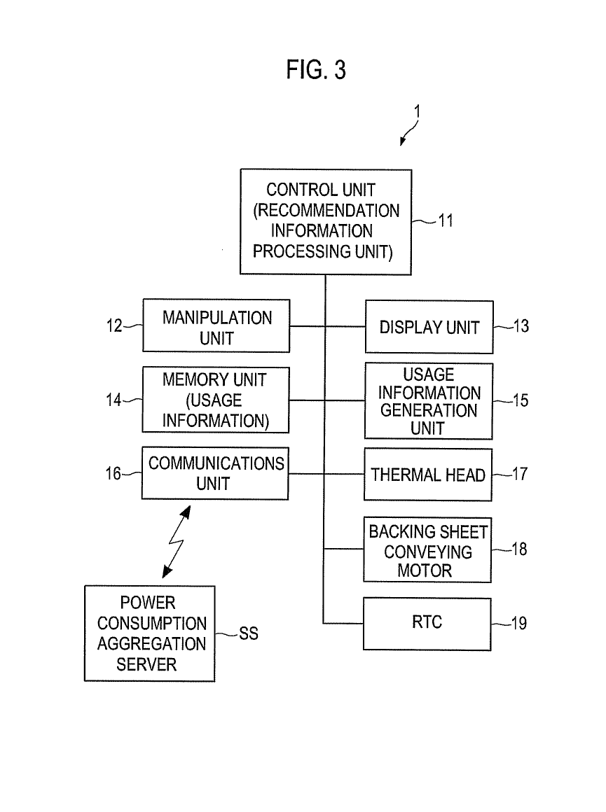

The printing system according to one embodiment will be described in detail referring to FIGS. 1 to 4. As shown in FIGS. 1 to 4, the printing device 1 includes a control unit 11 configured to control the entire operation of the printing device 1, a manipulation unit 12 provided, for example, at the front side of the printing device 1 and configured to provide a manipulating signal to the control unit 11, which is generated based on an instruction from a user, and a display unit 13, e.g., employing an LCD (liquid crystal display) or the like, configured to display a manipulation menu which will be described later in detail. The printing device 1 further includes a memory unit 14 including a ROM (Read Only Memory), a RAM (Random Access Memory), a flash ROM or the like. Specifically, the ROM may be configured to store manipulation information, setting information, a running program and so on, and the RAM may be configured to store the above described usage information in addition to the manipulation information, setting information, running program and so on. The printing device 1 further includes a usage information generation unit 15 configured to measure, compile and store in the memory unit 14 the usage information (the supply, the working time, the operating time, and the electric energy). Further, the printing device 1 includes a communications unit 16 configured to communicate with an outside entity such as a host computer H operated on the outside by a user, and the power consumption aggregation server SS that will be described later in detail, through communication protocols such as wired communication (e.g., RS-232C (Recommended Standard-232C), Centronics, USB, and LAN (Local Area Network)), wireless communication (e.g., IrDA (Infrared Data Association), Bluetooth (registered trademark), and wireless LAN), etc. The printing device 1 further includes a thermal head 17 configured to print on a recording medium such as a label under the control of the control unit 11, a backing sheet conveying motor 18 configured to convey a backing sheet on which the recording medium such as a label is attached, and an RTC (Real Time Clock) 19 configured to measure the working time and the operating time of the printing device 1. The RTC 19 may measure (or calculate) the electric energy consumption of the printing device 1 based on previously measured values of the working time and the operating time.

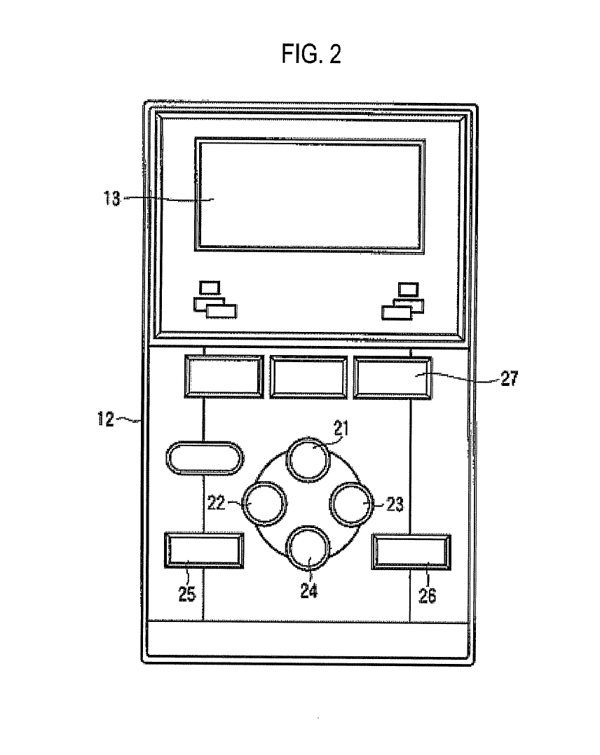

As shown in FIG. 2, the manipulation unit 12 may include an upward key 21, a leftward key 22, a rightward key 23, a downward key 24, a cancel key 25, an enter key 26, and a pause key 27.

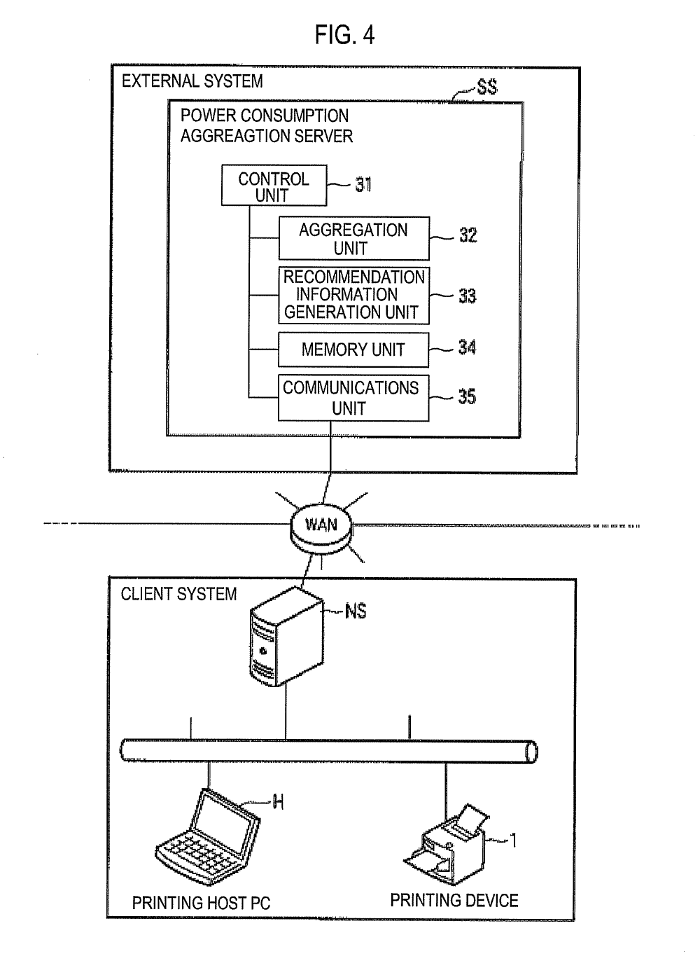

As shown in FIG. 4, the printing device 1 with the above described configurations may communicate with the power consumption aggregation server SS as well as other client devices via a network, such as a network server NS, the printing host computer H through which a user make manipulations for printing in the printing device 1.

The power consumption aggregation server SS includes a control unit 31 configured to control the entire operation of the server, an aggregation unit 32 configured to aggregate a plurality of use information respectively provided from a plurality of the printing devices 1, a recommendation information generation unit 33 configured to generate the recommendation information, for example, on how to minimize the power consumption, based on the aggregated usage information, and provide the generated recommendation information to the printing devices 1. The power consumption aggregation server SS may further include a communications unit 35 configured to communicate with the printing devices 1 by way of wired or wireless communications, and a memory unit 34 configured to store the usage information, recommendation information, various kinds of operation programs, etc.

In response to the user's manipulation of the manipulation unit 12 or the printing host computer H, which is under the control of the control unit 11, the printing device 1 with the above described configurations, for example, prints price information or the like on a recording medium such as a label attached on a backing sheet by the thermal head 17, conveys the backing sheet by the backing sheet conveying motor 18, and discharges the recording medium (i.e., the printed label) to the outside of the printing device 1. The above process may be conducted by, e.g., manipulating the manipulation menu by using any one of the upward key 21, the leftward key 22, the rightward key 23, the downward key 24, the cancel key 25, and the enter key 26.

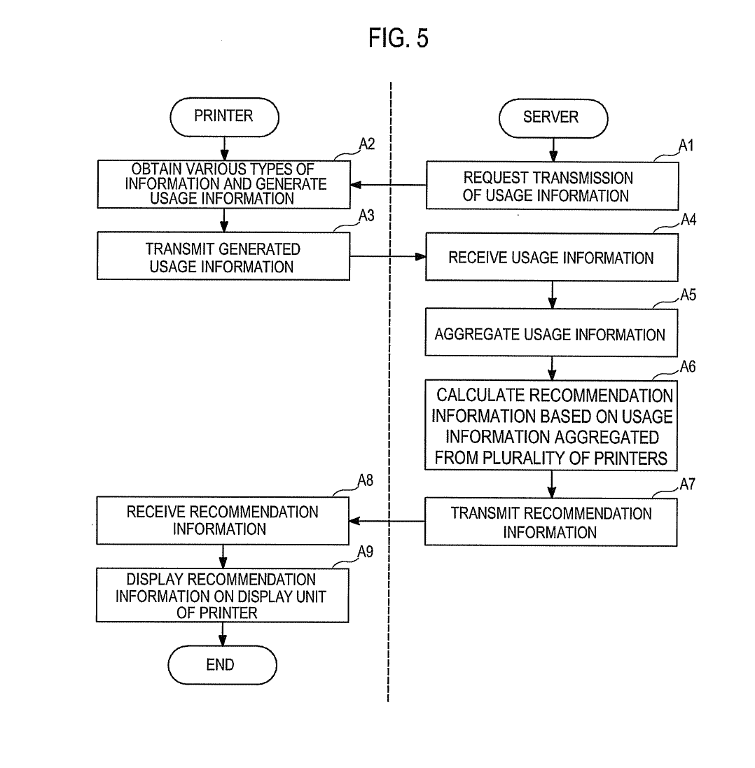

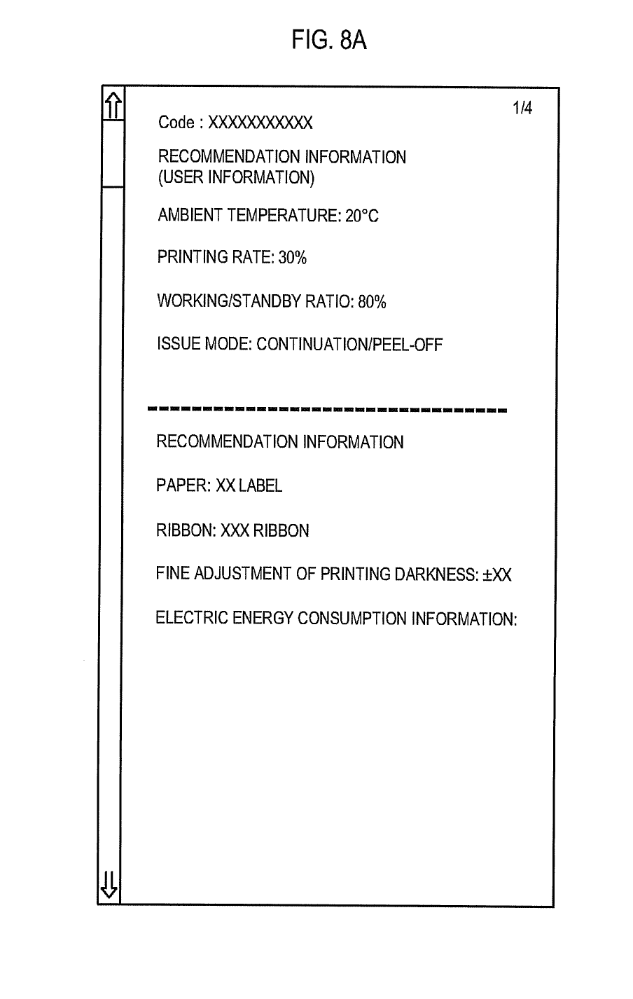

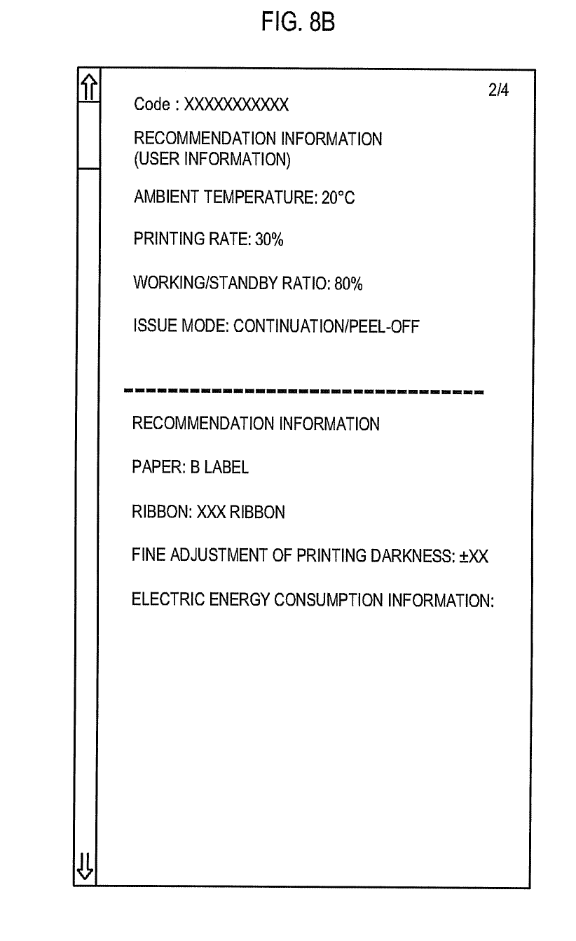

In the above-described printing system, the power consumption aggregation server SS performs a recommendation process. Specifically, in the recommendation process, the power consumption aggregation server SS generates the recommendation information on how to achieve a maximum reduction in power consumption based on the usage information (the supply, the working time, the operating time, and the electric energy consumption) aggregated from the plurality of the printing devices 1. Then, the power consumption aggregation server SS provides the generated recommendation information to each of the respective printing devices 1 so that the printing devices 1 can set their usage environments based on the recommendation information. The detailed description of the recommendation process will be described below with reference to FIGS. 5, and FIGS. 8A and 8B.

In the printing system illustrated in FIG. 4, the power consumption aggregation server SS transmits to the printing device 1 via the communications unit 35 a request signal for requesting transmission of the usage information (Act A1). The request signal may be transmitted at predetermined time intervals or at regular intervals, e.g., once a day or once a week.

The following is an illustrative example of a method of processing the usage information. The printing device 1 is provided with a storage device such as a flash ROM in which the usage environment such as conditions and requirements for performing a printing operation can be stored or registered. The control unit 11 and the usage information generation unit 15 of the printing device 1 obtain various types of information and generate usage information on the usage environment including information on a ribbon in use, a paper in use, a use temperature, product information (including printing options) (Act A2). The control unit 11 and the usage information generation unit 15 also registers the usage environment in a registration area such as the memory unit 14 and store the usage information such as status of using the above-described conditions in the memory unit 14. The control unit 11 and the usage information generation unit 15 connect with the power consumption aggregation server SS via the network server NS and an external WAN (Wide Area Network) in response to the request signal from the power consumption aggregation server SS and transmit the usage information registered and stored in the memory unit 14 to the power consumption aggregation server SS (Act A3). The communications unit 35 of the power consumption aggregation server SS receives the usage information from the printing device 1 (Act A4). Thereafter, in the manner as described above, the aggregation unit 32 aggregates the plurality of usage information from the plurality of printing devices 1 (Act A5).

The following is an overview of exemplary usage information. Specifically, the usage information includes pre-registered information and under-operation information. The “pre-registered information” refers to information on conditions and requirements for printing which can be set prior to operating the printing device 1, e.g., supply information, an operation environment, and a working environment as shown below. The “under-operation information” refers to information which can be determined and updated in real time after the printing operation is started, e.g., an operation environment such as a printing rate and a working environment such as a printing time. The following is more detailed explanation of the pre-registered information and the under-operation information:

(A) Pre-registered information
(1) Supply information
   manufacturer and product number of label paper, tag paper, or receipt paper
   manufacturer's name and product number of ribbon

(2) Operation environment
printer configuration (standard product number, inclusion or exclusion of option device, etc.)

(3) Working environment
number of systems under currently working
printing interface information
working time
number of papers used in a day
use temperature range
   (B) Under-operation information

(1) Operation environment
printing configuration of printer (printing rate)

(2) Working environment
printing interface information
printing time/idle time (which refers to a standby ratio, where the “printing time” refers to a period of time during which printing is being performed, and the “idle time” refers to a period of time during which printing is not being performed.)
number of printed papers since power was turned on
use temperature

Based on the usage information (e.g., including information in the above-described format) aggregated from the plurality of printing devices 1, the power consumption aggregation server SS compares the usage information with reference statistical data and calculates the recommendation information associated with a similar environment, including the following (Act A6):

(1) Information on the electric energy consumption depending on usage of supply (in each use environment)

(2) Information on the electric energy consumption depending on the device configuration

(3) Information on the recommendation setting (limiter information of each parameter)

The above information may be displayed individually for each environment or printing device 1 or all together for the plurality of printing devices 1 for comparison therebetween.

The power consumption aggregation server SS transmits the recommendation information (e.g., information on the power consumption) to each printing device 1 (Act A7). The communications unit 16 of the printing device 1 receives the recommendation information (Act A8). The control unit 11 stores the recommendation information in the memory unit 14. Further, the control unit 11 displays on the display unit 13 the recommendation information to be provided to the user (Act A9).

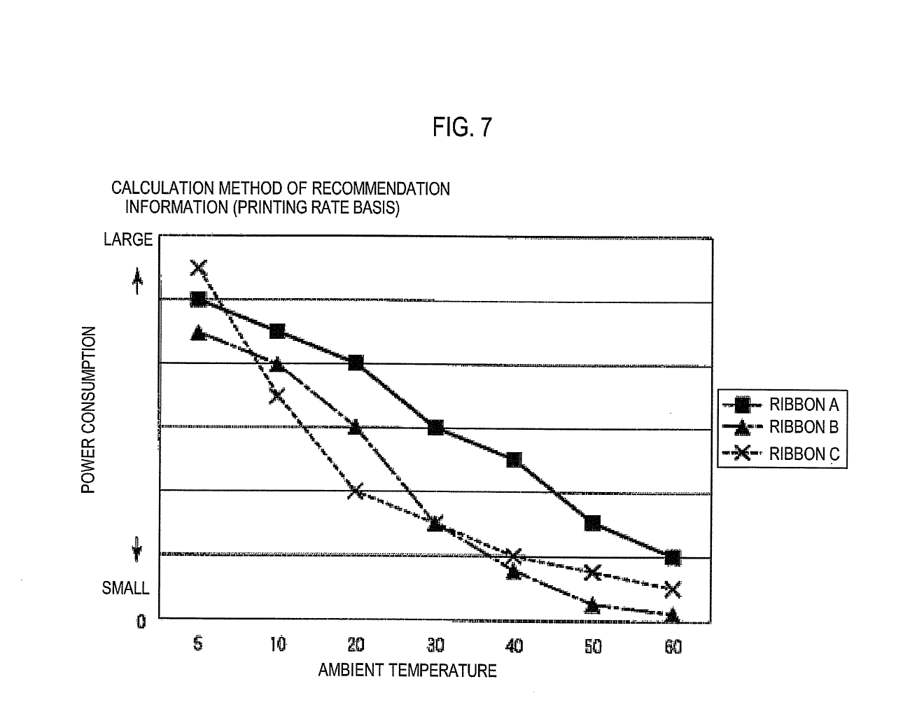

The method of determining the recommendation information may include using a graph showing a relationship between power consumption and an ambient temperature, as shown in FIG. 7. FIG. 7 is a graph which depicts statistical data showing the relationships between the ambient temperature and the power consumption for various kinds of ribbons, aggregated from the respective printing devices 1 whose printing rates are commonly fixed at 30%. The power consumption required for an environment including a combination of a specific ambient temperature and a selected kind of a ribbon can be estimated based on the statistical data shown in the graph. Further, if a target power consumption value is determined, a specific kind of a ribbon for the target power consumption value may be determined based on the statistical data shown in the graph.

FIG. 7, for example, shows that the power consumption varies with the change of the ambient temperature. Specifically, at the ambient temperature of 20° C., the power consumption is the lowest when the ribbon C is used. At the ambient temperature of 60° C., the power consumption is the lowest when the ribbon B is used. Based on the statistical data graph, when the printing is performed at, e.g., the printing rate of 30% and the ambient temperature of 20° C., the use of the ribbon C may be recommended for the lowest power consumption. Thus, the ribbon C is provided in the recommendation information.

In some embodiments, in determining the recommendation information, weights of the respective kinds of ribbons or the amount of the printout per unit time may be considered.

FIGS. 8A and 8B show an exemplary display screen displayed on display unit 13 of the printing device 1 showing a configuration of the recommendation information including the ambient temperature, the printing rate, the working/standby ratio of 80% and the printing mode. In this embodiment, multiple patterns of the recommendation information may be presented to the user. For example, FIGS. 8A and 8B represent two patterns out of four patterns of the recommendation information. Although specific values such as average values of the ambient temperature, the printing rate and the working/standby ratio are listed the recommendation information in this embodiment, certain ranges of values may be listed therein instead of the specific values. Further, while the screen of FIG. 8A displays the whole part of the recommendation information, the screen may display a part of the recommendation information. In such a case, the remaining part of the recommendation information may appear from the bottom of the display by scrolling down thereof using any related key on the manipulation unit 12. For example, three lines of information in the remaining part may appear on the display by one stroke of a scrolling down key (not shown).

In the printing device 1, the recommendation information may be used as reference data to be compared to actual operation data, which may be used in determining whether to issue an alert message or not. Specifically, the control unit 11 of the printing device 1 stores the provided recommendation information in the memory unit 14 and sets reference data (or an alert level) based on the recommendation information. If each parameter of the conditions and requirements of the usage environment of the printing device 1 in use deviates from the alert level by more than a specific value, the control unit 11 may immediately provide an alert message to the user through the display unit 13, the printing host computer H, or the like. As a result, the respective parameter values of the printing device 1 may be maintained as recommended in the recommendation information, thereby achieving a reduction in the power consumption.

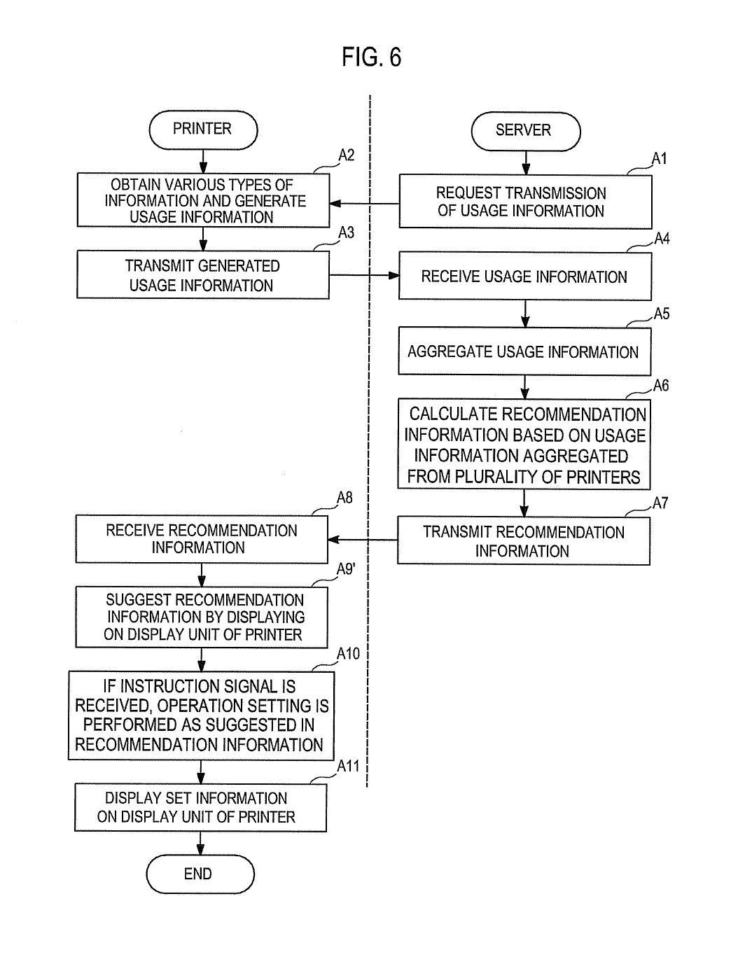

As shown in FIG. 6, the printing device 1 may perform a reduction in the power consumption through an operation setting based on the provided recommendation information. For example, the control unit 11 of the printing device 1 receives the recommendation information from the power consumption server SS and displays on the display unit 13 a suggestion for the operation setting that specifically suggests the contents of the recommendation information (Act A9′). The printing device 1 receives an instruction signal from a user, who may accept the suggestion and perform a “SET” manipulation or the like through the manipulation unit 12 and the display unit 13, so that the operation setting is performed as suggested in the recommendation information and thus the power consumption can be reduced (Act A10). Then, the control unit 11 of the printing device 1 displays the information set in Act A10 on the display unit 13 (Act A11).

The suggestion in the recommendation information may be, specifically, setting a limit with respect to a setting value for fine adjustment of darkness in printing according to the supply in use, lowering a printing speed, cutting a power supply required for unused options, shortening a time required in a transition to a low power consumption status, or the like. With respect to the operation modes (e.g., printing modes) of the printer, for example, if the peel-off mode for peeling off a printed label from a backing sheet is set to be off, a peel-off sensor for detecting whether or not the printed label is taken off from the backing sheet is not used to achieve the power saving. As such, the above process of operation setting may ensure the suppression of the power consumption.

In Act A10, the operating condition is set by the control unit 11 as suggested in the recommendation information, after being displayed on the display unit 13 and accepted by the user in Act A9′. However, in the case the user does not accept the suggestion or does not provide a manipulation instruction, the control unit 11 may automatically perform a setting operation according to the recommendation information after receiving the recommendation information from the power consumption aggregation server SS. The automatic setting of the control unit 11 ensures the suppression of power consumption and saves the user from having to perform such manipulation.

As used in this application, entities for executing the operations can refer to a computer-related entity, either hardware, a combination of hardware and software, software, or software in execution. For example, an entity for executing an operation can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus, or can be installed in the apparatus from a computer readable storage medium storing the program therein. The form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS (Operating System) in the apparatus.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing system comprising a printing device and a server device,
the printing device including a memory unit configured to store usage information; and
the server device including a communications unit configured to communicate with the printing device; an aggregation unit configured to obtain the usage information from the printing device via the communications unit and aggregate the obtained usage information; and a recommendation information generation unit configured to generate recommendation information for the printing device based on the usage information aggregated by the aggregation unit and provide the recommendation information to the printing device via the communications unit.

2. The system of claim 1, wherein the recommendation information generation unit is configured to generate the recommendation information with respect to a usage environment of the printing device which includes at least one of a kind of a recording medium for use in the printing device, a kind of a ribbon for use in the printing device and a printing rate of the printing device.

3. The system of claim 1, wherein the recommendation information generation unit is configured to generate the recommendation information for the printing device based on at least one of an ambient temperature, a printing rate and a standby ratio.

4. The system of claim 1, wherein the recommendation information generation unit is configured to generate the recommendation information for reducing power consumption of the printing device.

5. The system of claim 1, wherein the printing device is configured to display on a display unit the recommendation information provided from the server device and change a usage environment of the printing device according to the recommendation information, upon receiving an instruction signal for accepting the recommendation information.

6. The system of claim 1, wherein the recommendation information includes at least one of information on electric energy consumption depending on a supply for use in the printing device and information on electric energy consumption depending on a configuration of the printing device.

7. The system of claim 1, wherein the usage information includes information on a plurality of usage environments of the printing device, and
wherein the recommendation information generated by the recommendation information generation unit includes information for reducing power consumption of the printing device with respect to the respective usage environments.

8. The system of claim 1, wherein the usage information includes at least one of a supply, a working time, an operating time and an electric energy consumption of the printing device.

9. A server device comprising:
a communications unit configured to communicate with an external printing device;
an aggregation unit configured to obtain usage information including at least one of a supply, a working time, an operating time and an electric energy consumption from the external printing device via the communications unit and configured to aggregate the obtained usage information; and
a recommendation information generation unit configured to generate recommendation information for the external printing device and provide the recommendation information to the external printing device via the communications unit.

10. The device of claim 9, wherein the recommendation information generation unit is configured to generate the recommendation information on a usage environment which includes at least one of a kind of a recording medium for use in the external printing device, a kind of a ribbon for use in the external printing device, and a printing rate of the external printing device.

11. The device of claim 9, wherein the recommendation information generation unit is configured to generate the recommendation information for the external printing device based on at least one of an ambient temperature, a printing rate, and a standby ratio.

12. The device of claim 9, wherein the recommendation information generation unit is configured to generate the recommendation information for reducing power consumption of the external printing device.

13. The device of claim 9, wherein the aggregation unit is configured to obtain the usage information from the external printing device at predetermined time intervals.

14. The device of claim 9, wherein the recommendation information includes at least one of information on electric energy consumption depending on a supply for use in the external printing device and information on electric energy consumption depending on a configuration of the external printing device.

15. The device of claim 9, wherein the usage information from the external printing device includes information on a plurality of usage environments of the external printing device, and
wherein the recommendation information generated by the recommendation information generation unit includes information for reducing power consumption of the printing device with respect to the respective usage environments.

16. A printing device comprising:
a memory unit configured to store usage information including at least one of a supply, a working time, an operating time and an electric energy consumption of the printing device; and
a providing unit configured to provide the usage information to an external server device via a communications unit upon receiving a request for providing the usage information from the external server device.

17. The device of claim 16, wherein the memory unit includes a real time clock configured to measure a working time and an operating time of the printing device.

18. The device of claim 16, further comprising a control unit configured to display on a display unit recommendation information provided from the external server device and change a usage environment of the printing device according to the recommendation information, upon receiving an instruction signal for accepting the recommendation information.

19. The device of claim 18, wherein the recommendation information includes the usage environment of the printing device which includes at least one of a kind of a recording medium for use in the printing device, a kind of a ribbon for use in the printing device, and a printing rate of the printing device.

20. The device of claim 18, wherein the recommendation information is generated based on at least one of an ambient temperature, a working rate and a standby ratio of the printing device.
